(19) United States
(12) Patent Application Publication
(10) Pub. No.: US 2011/0043590 A1
(43) Pub. Date: Feb. 24, 2011

(54) HEAT TRANSFER PRINTING DEVICE AND PRINTING METHOD

(75) Inventor: Mirko Penzo, Barcelona (ES)

Correspondence Address: VANGELIS ECONOMOU;C/O ECONOMOU IP LAW, 111 West Washington Street, Suite 1301, CHICAGO, IL, 60602, US

(73) Assignee: I.T.W. Espana, S.A., Barcelona (ES)

(21) Appl. No.: 12/159,285

(22) PCT Filed: Dec. 28, 2006
(86) PCT No.: PCT/IB2006/003786

§ 371 Date: Sep. 24, 2009

(30) Foreign Application Priority Data
Dec. 30, 2005 (ES) 200503251

(51) Int. Cl. B41J 2/325

(52) U.S. Cl. 347/217

(57) ABSTRACT

Constant tension in the thermal printing ribbon is maintained in a loading drum placed after the thermal print head that directs the ribbon by means of a planetary pivotable support lever arm to define a loop, thereby maintaining constant tension throughout the printing stage to ensure operational quality. The printing method includes threading the thermal printing ribbon between the pivotable support lever arm and the cylindrical drum, and the mechanism retains the printing ribbon against the loading drum by a biasing force on the lever arm, the lever arm being kept in biasing mode during the printing operation.

### CROSS REFERENCE TO RELATED APPLICATIONS

This is a National Phase application of PCT Application No. PCT/IB2006/003786, filed on 28 Dec. 2006 (published as WO 2007/077482), claiming priority of Spanish Application No. 2005-03251, filed on Dec. 30, 2005, and also is a continuation-in-part of pending U.S. patent application Ser. No. 10/986,991, filed Nov. 15, 2004, which claims foreign priority from Spanish Application No. 2003-02818 filed on Dec. 1, 2003, the entire specifications of each of the above referenced priority documents being incorporated by reference herein.

### BACKGROUND OF THE INVENTION

1. Field of the Invention

The present invention relates to a printing device for application in heat transfer printing machines, as well as to the printing method itself, and more specifically, to heat transfer printing machines in which the tape on which printing is performed is maintained in a range of tension while simultaneously registering the tape with the printing head.

2. Background Art

This invention is directed to a printing device that incorporates means to provide a constant tension of the printing ribbon. A loading drum placed immediately after the thermal print head that draws the ribbon towards itself, and thereby forming a loop, and so maintains a constant tension during the printing stage to ensure quality of the operation.

Printing machines with a thermal head transfer the ink from a printing ribbon to the material to be printed by heating a number of points in the thermal print head to release the ink.

In first generation printing machines of this type, the transfer ribbon transport means were driven by a motor in the take-up spool and were provided with various possible combinations of braking devices in the feed spool to control the amount of ribbon supplied.

During the printing stage it is crucial that the tension of the transfer tape or ribbon be as constant as possible in order to obtain a high printing quality. To achieve a constant tension in the tape, some manufacturers have developed moving devices that move to maintain the ribbon tension constant, thereby resulting in a relative motion between the print head and the ribbon, with the feed spool and take-up spool still.

This is the case in U.S. Pat. No. 5,975,777, which discloses an alternative method and printing apparatus incorporating a shuttle that constitutes the transport element of the ribbon with respect to the thermal head during printing, while at least one of the spools remains still. This complex shuttle system requires the tape to be spooled through multiple rollers to maintain tension by back and forth motion of the complete shuttle.

Other prior art methods used to maintain a constant ribbon tension involve acting on the various speeds of the feed and take-up spool motors. For example, U.S. Pat. No. 5,873,662 utilizes a brake mechanism on a dancer arm that controls the amount of tension on the ribbon by braking or releasing the unwind or feed reel. Others of these tensioning techniques include complicated and redundant processes, sometimes requiring elaborate software used to theoretically calculate the amount of tension that should be on the loop of tape that are continually calculating and adjusting during the printing process. For example, U.S. Pat. No. 5,366,303 to Barrus et al. discloses a complicated set of stepper motors acting as feed and take up spool motors that are controlled by a controller. The controller, using a complicated algorithm, calculates and counts the number of zero crossings in an electrical waveform, thereby to determine the amount of needed tension in the tape. Others have proposed tape or ribbon tensioning apparatus for heat transfer printing, including U.S. Pat. No. 6,082,914 to Barrus et al., U.S. Pat. No. 6,247,859 to Butcher, U.S. Pat. No. 7,052,194 to Mills and U.S. Pat. No. 7,150,572 to McNestry et al.

These systems result in complex and hard to manage mechanisms, having poor precision as well as speed-related limitations determined by the inertia of the mechanical devices when these are set in motion. Moreover, none of these proposals have provided an efficient manner to maintain tension that relies on a sensed tension mechanism that does not require continual calculations of the expected or theoretical diameter of the tape being wound or released form a spool. Development of a device to solve the above-described problems is desirable.

### SUMMARY OF THE INVENTION

What is disclosed and claimed herein is a heat transfer printing device comprising a thermal print head, a feed spool for printing ribbon driven by a motor, entry guide rollers that direct the printing ribbon arriving from the feed spool toward the printing area, the printing area having a printing roller for supporting the material to be printed, a take-up spool driven by a motor to which the printing ribbon is directed with the aid of guide rollers, and a tape tension mechanism for monitoring and actuating a tensioner to maintain the tension of the printing ribbon between the feed spool and the take-up spool, the tension mechanism including a cylindrical loading drum having a surface and a support lever arm configured to provide a rotary force to the printing ribbon when rotating, which is placed after the thermal print head to which the printing ribbon is attached, by forming a loop around the loading drum, and thereby to maintain the tension of the ribbon during printing.

In an other embodiment, the heat transfer printing device comprises at least one input guide roller that guides a printing ribbon towards a drum placed after a thermal printing head and before output guide rollers, and further comprises a swivelling roller that turns about the drum with the printing ribbon located between them, forming a loop of printing ribbon on the drum that establishes a tension in the ribbon during printing.

This invention is an alternative and improved method as used for the printing process and comprises maintaining the printing ribbon on a loading drum by spring tension;

The heat transfer printing device solves the needs described above as it ensures a constant tension of the print head during the printing stage in a simple and elegant manner that is essentially instantaneously sensitive to perceived changes in the tape tension. Moreover, the sensing and instantaneous reactions occur in response to the tape tension, and do not require calculation or other data manipulations of, for example, the average diameter of the spools including the amount of tape remaining or taken in on the feed or supply and take-up spools 20, 22, respectively. The inventive tape tensioning mechanism is based fundamentally on the incorporation of a loading drum which in conjunction with a support lever arm on which a rotating planetary guide roller 32 extends the printing ribbon 15 to its complete length and continues to monitor the tension so as to maintain the tension in a very tight range. The planetary guide roller 32 is preferably disposed between the thermal print head 12 (FIG. 1) and the ribbon take-up spool 22. The rotating planetary wheel is constrained to move in a partial orbit around a on which the ribbon adheres to form a loop that increases, tensioned, during the printing stage.

In a main embodiment of the invention, the drum is adjacent to a support arm that includes a guide roller for guiding tape or ribbon by forming a loop. The tape or ribbon loop is formed by the planetary guide roller and drum acting in concert to retain the print ribbon against the drum surface while also taking up any slack and being capable of easily providing extra ribbon to relieve any tension caused by the sudden binding or other resistance caused in the course of the printing process. The ribbon is retained on the drum by the planetary guide roller which extends the ribbon in a loop with a variable length, determining a tension that is maintained constant during the printing process to provide greater printing quality.

The force generated by the drum on the print ribbon will depend on the structural configuration of the planetary guide roller, the drum and the distance between them, as well as on the amount of biasing force that is provided to the planetary arm to retain it in an equilibrium position. The ribbon remains in tension during the printing stage, and printing will commence when the speed of the printing ribbon and that of the material to be printed are the same.

The amount of ribbon transferred through the printing station is partially controlled by a rotation sensor associated to a guide roller. This rotation sensor controls the tangential speed of the associated roller and sends a signal correlating the amount of ribbon transferred to the printing station so as to facilitate regulation of the revolution parameters of the ribbon feed spool motor and take-up spool motor.

The loop start and end generation and maintenance of an equilibrium position, and thus governing the tension and position, are determined by a number of factors, including the sensor values of the corresponding plurality of planetary lever arm sensors disposed in an area adjacent the loading drum. Ideally, the sensors are in a configuration that sense the position of the planetary lever arm and guide roller which immediately indicates to the spool motors whether additional slack or tightening of the tape is needed. Thus, when the ribbon reaches the position of the first sensor it will be detected and when printing begins the loop will be extended, while when the ribbon reaches the position of the second sensor it will be detected, activating the printed ribbon take-up system by the required amount. Although two sensors are shown in FIG. 1, additional sensors may be utilized at more extreme positions to provide more urgent signals for take-up or slackening of the spool motors by a more drastic amount, depending on the position of the lever arm. Alternatively, as shown in FIGS. 5-7, the sensor may be a dedicated mechanism for monitoring the exact position, including the most recent trends of the positions, to enable the sensor to anticipate the need to release or take up more ribbon.

The loop is taken up in the required amount according to the size of the printing by a motor associated to the printing ribbon take-up spool. To facilitate the take-up of this loop, the ribbon may be further controlled by an optional brake placed before the take-up spool.

### BRIEF DESCRIPTION OF THE DRAWINGS

The present invention will now be discussed in further detail below with reference to the accompanying drawing figures to provide a better understanding of the invention, the drawing figures provided being an integral part of the invention in which, for purposes of illustration and in a non-limiting sense, the following has been shown:

FIG. 1 illustrates in a schematic outline the elements of a printing device according to the present invention immediately prior to the engagement of the thermal print head;

FIGS. 2 to 4 show in several schematic views the transfer ribbon tensioning sequence in which a loop is formed by the invention of FIG. 1;

FIG. 5 illustrates in a detailed view of the loading drum with the associated planetary roller guide according to the preferred embodiment of the invention;

FIG. 6 shows a perspective view of the sensor mounted on the rear wall of the housing of the device;

FIG. 7 shows a cross-sectional view of the sensor and wall shown in FIG. 6, and illustrating the interrelationship of the elements of the invention;

FIG. 8 is a perspective view of the preferred embodiment of the angular position indicator, monitoring and control mechanism for the thermal printing device of FIG. 1; and

FIG. 9 is a perspective view of a CPU controller of the show in a separate portion of the inventive device and including an embodiment of the operational indicator.

### DETAILED DESCRIPTION OF THE PREFERRED EMBODIMENTS

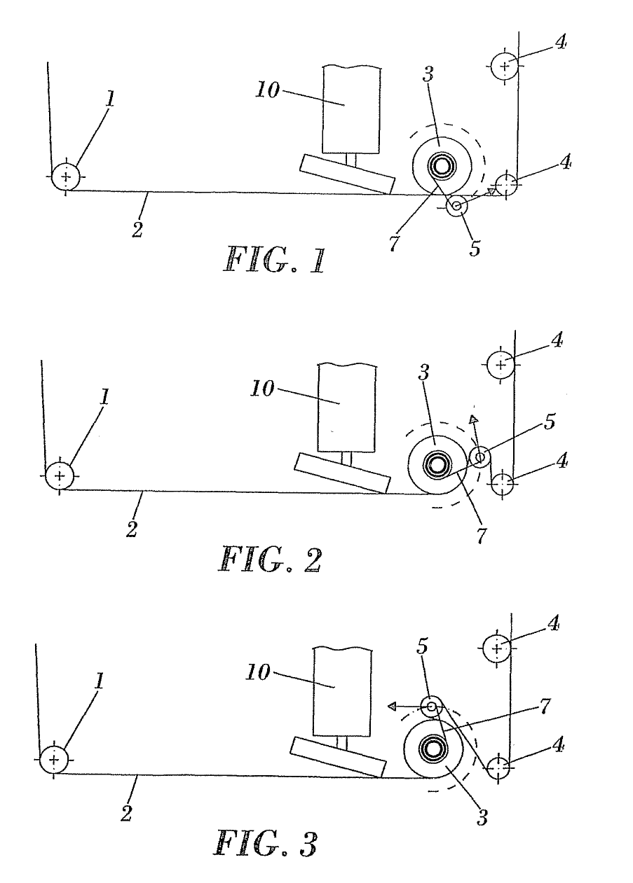

Referring now to the schematic illustrations of FIGS. 1-4, the inventive heat transfer printing ribbon tensioning device 10 and its operation will be described. The heat printing ribbon tensioning printing device 10 should be considered as being a part of a heat transfer printing assembly, generally designated as 100, that includes a thermal print head 12, a feed spool 20 containing a roll of printing ribbon 15, the spool 12 being driven by a motor (not shown), a plurality of entry guide rollers 14 that direct the printing ribbon 15 from the feed spool 20 toward a printing area adjacent a print head 12 and a take-up spool 22 onto which the heat transfer printing ribbon is wound after use. Associated with the heat transfer printing ribbon 15 and guide rollers 14, is a rotation sensor 26 for sensing the direction and speed of rotation of at least one of the rollers 14. The printing area, generally designated as being the area around the device 10, includes a printing roller 26 on which the material to be printed 13 is transported. Associated with the take-up spool 22, which is also driven by a motor (not shown), guide rollers 16 direct the printing ribbon 15 from the printing area toward take-up spool 22, as shown.

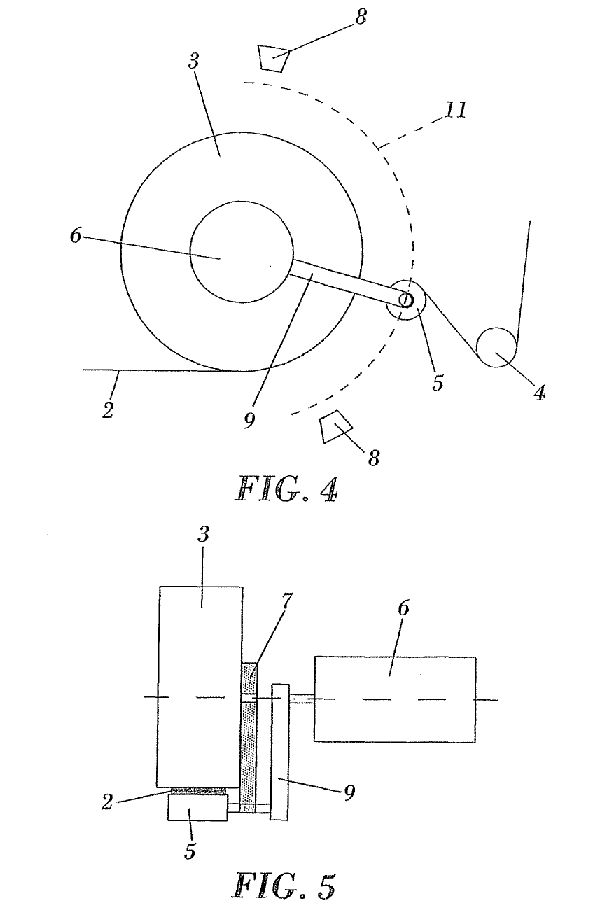

The printing ribbon tensioning device 10 may optionally include a brake 23 disposed between two of the guide rollers 16, 16 that partially brakes the printing ribbon 15 to simplify the subsequent loop take-up stage by actuating the take-up loop 22, as shown in FIGS. 1 and 4 and described below. No such brake mechanism is necessary for operation of the inventive and in the preferred embodiment of the inventive transfer printing ribbon tensioning device, no brake is present.

Although shown in FIG. 1, two sensors A and B may correspond to the minimum and maximum positions between which the ribbon loop may run when the printing ribbon 15 is shown in the tensioning operation (FIG. 3-4), and as is described and illustrated in the aforementioned parent of this invention, (U.S. patent Ser. No. 10/986,991, published as U.S. Pat. Pub. 2005-0117956), but the preferred method is to have the sensors mounted on the back of the device as is shown in FIGS. 5-7. The sensors A, B may be any of a number of sensors, and can comprise, for example, light or proximity sensors, or they may be more precise, as is described below with respect to the preferred embodiment of the position sensor of the support arm 30 (FIG. 5) and tensioning planetary guide roller 32. A guide 29 may be provided as shown in FIG. 1 to guide the ribbon 15 into the area in which the tensioning mechanism 10 operates to provide constant tension to the ribbon 15. The guide can be a rotating wheel, as are guides 14, 16, or a stationary pin (not shown) that is attached to the wall support of the mechanism 10.

The inventive heat transfer printing ribbon tensioning device 10 comprises several elements that are essentially identical to those of the parent invention, (U.S. patent Ser. No. 10/986,991, published as U.S. Pat. Pub. 2005-0117956), and reference is made thereto for a more concise explanation of the structure and operation thereof. Where the elements are similar or identical, the description of the elements in the parent is incorporated as if fully described herein. To recapitulate, the printing mechanism comprises a printing head 12 attached to an actuated arm 36 that is in operational engagement with an actuator 38, for example as solenoid. When the printer head 12 is commanded to print, the actuator 38 is actuated, thereby moving the printer head 12 in a downward direction toward the ribbon or tape 15, until it meets the tape, and starts the printing operation, as shown in FIGS. 3 and 4 to print on the material 13 that is being printed on.

The heat transfer printing ribbon tensioning device 10 comprising the invention is shown schematically in greater detail as a sequence of stages in FIGS. 2-4, in which the mechanism utilized for maintaining the desired amount of tension in the printing ribbon is discussed. As shown, FIGS. 2-4 show several stages of the printing process and tensioning mechanism 10 and the manner in which the tension is maintained in the ribbon during the printing operation. The stage before the printing operation is commenced is shown in FIG. 1, and the beginning stage is shown in FIG. 2, wherein the printer is not yet operational. The next stage shown in FIG. 3 is one in which the printer has begun to print, and the last stage (FIG. 4) shows the mechanism approaching its limit of accommodating excess ribbon 15 that must be taken in by operation of the motors that drive the take-up spool 22 and the feed spool 20.

Tape or ribbon 15 is drawn thorough the device 10 by dispensing the ribbon 15 from the feed spool 20 and extending it around the first set of guides 14 and past rotation sensor 26. The ribbon 15 is passed through a space between the guide 28 and a ribbon loop drum 40 which provides a surface 42 upon which the tape or ribbon 15 forms a loop 17 (FIGS. 3-4), as previously described. Loop 17 is formed automatically upon the printer head 12 commencing the printing operation, which begins by the actuator actuating the shaft 36 toward the ribbon 15. As the printer head 12 engages the printing ribbon 15, this causes the ribbon 15 to bend from a linear condition toward an angled position as shown in FIG. 3. Simultaneously, the planetary support lever arm 30, including the rotating guide roller 32, shifts position and becomes disposed at the first or initial position which is at a point along the crescent opening 44 about half way between the two end points 45 (FIG. 1). At this position, the lever support arm 30 can move in one direction if the ribbon tension is too tight and in the other direction if too slack, so as to accommodate the variability caused by the friction of the printing head 12 coming into contact with ribbon 15.

The inventive tape tensioning mechanism incorporates a loading drum 40 which in conjunction with a support lever arm 30 on which a rotating planetary guide roller 32 is mounted, extends the printing ribbon 15 to its complete length without breaking it and continues to monitor the tension so as to maintain the ribbon tension in a very tight range. The planetary guide roller 32 is preferably disposed between the thermal print head 12 (FIG. 1) and the ribbon take-up spool 22. The rotating planetary guide roller 32 is constrained to move in a partial planetary orbit around the drum 40 so that the ribbon 15 forms a loop 17 that has an increase in tension or decrease in tension, as required, during the printing process.

As shown most clearly in FIG. 7, a central rotating shaft 42 extends from and aperture in the housing of motor 48 to drum 40, which itself extends through an aperture 49 in the wall 50 of a housing of the printer device 10. The aperture 49 may be concentric or even coterminous with the crescent aperture 44 through which the planetary lever arm 30 partially revolves, but the aperture 49 should be large enough for passage of the drum 40 therethrough to permit easy installation in case of any needed repair. The motor 48 and shaft 42 combination only operates during and initial start up stage of the printing process, until an equilibrium position of the lever arm is established, and the drum 40 is then permitted to rotate freely in a limited range around that equilibrium position, as described below.

An appropriate mounting scheme is necessary for mounting the motor 48. As shown, the mount can comprise a bracket 52 that has a second aperture through which drive shaft 42 passes, the bracket 52 itself being mounted on the wall 50 by means of a spacer 54 that is connected by an appropriate connection, such as a plurality of bolts 56, connecting the bracket 52 to the wall 50. While this connection is shown as being a preferred method, other connection schemes, for example, an attached housing (not shown) dedicated to house and orient the motor 48, may be more appropriate as the features of the invention are developed in the future.

At this position, correlating essentially to position B (FIG. 1) in relation to the previously described embodiment of the aforementioned parent invention (U.S. patent Ser. No. 10/986,991, published as U.S. Pat. Pub. 2005-0117956), the ribbon speed is preset by the position as last provided, if in the intermittent mode, and at the constant adjustable speed in the continuous mode. At this position, the lever support arm 30 is left to “float”, that is, it reaches an equilibrium position that is being biased by the biasing force (spring 210, FIG. 7) against the tension created by the ribbon. If the equilibrium is upset so that it is forced in one direction for too long and too far from the equilibrium, then the controller is signaled to either increase or decrease the tape speed, as needed to revert the position of the planetary lever support arm 30 back to the equilibrium position.

This concept of equilibrium of forces acting on the planetary lever support arm 30 and associated planetary guide roller 32 is a key feature of the invention. That is, the equilibrium is reached immediately upon the starting of the intermittent printing process, and the planetary guide roller 32 is positioned at a point approximately halfway between the two ends of the crescent shaped aperture 44, which may translate to about sensor B in FIG. 1. At this point, the planetary guide roller 32 can move easily in either direction, that is, clockwise in the direction of arrow CW or counterclockwise in the direction of arrow CCW (FIG. 5), depending on the forces acting on the ribbon 15 and causing tension thereon to be increased or decreased. As soon as the need to increase or decrease tension is sensed, then the controller will automatically increase or decrease the rotational speed of the spools 20, 22, thereby affecting the forces on the ribbon 15 and bringing the planetary guide roller 32 back into an equilibrium condition. Depending on the sensor mechanism and the biasing force, the reaction time to provide the return to the equilibrium point is such as to maintain the position at or near equilibrium irrespective of the printing speeds, or of motion of the tape or ribbon 15.

This feature is shown in FIGS. 4 and 5, wherein the lever support arm 30, including the planetary guide roller 32, is at the “loose ribbon” position, and the spring 210 has biased the planetary guide roller 32 position almost to the terminal point of the crescent aperture 44. At this position, if not before, the controller will assert its function and will provide a signal to the spools 20, 22 to speed up or slow down the take-up and feed in order to bring the tension of the ribbon 15 to a value that will bring the planetary guide roller 32 back to equilibrium.

Referring now to FIGS. 5, 6 and 7, the preferred embodiment of the sensor configuration 10 is shown. As described above, the drum 40 is driven by a motor 48 only at initial stages of the loop loading mechanism. After the initial stage, the motor ceases to control the operation of drum 40, which begins rotating only under the motive force provided by the frictional engagement of the surface of drum 40 with the tape or ribbon 15 as it is rotated around the drum 40. The only control is provided by the driving mechanism of the two stepper motors 20, 22 as is described above. In operative effect, the motor only acts as a support for the spindle or shaft 42 following the initial stages of establishing the initial angular position of the lever arm 30, and may provide a support for the concentric bushing ring 62.

The process control is preferably governed by a sensor and control system 300 (FIG. 9) that is immediately responsive to the indication sensed that will provide a signal to the feed and take-up drive motors (20, 22 FIG. 1) that the ribbon speed must be increased or decreased to adjust the tension at the printing head 12. The sensing operation may be any of a number of methods, and any type of sensor that is able to provide an immediate signal is available. For example, a series of LED lights (not shown) may provide information as a discrete signal of the angular position of the lever arm 30. However, as shown in FIGS. 6-7, the lever arm 30 is attached by a cantilevered connection mechanism to an electronic sensor, such as sensor system 49, which provides angular information of the lever arm 30 relative to the axis CL of rotation of the arm 30. The axis of rotation of the CL of rotation of the arm 30 may be identical to the axis of rotation of shaft 42. The sensor position is translated into a signal to the feed and take-up drive motors (20, 22, FIG. 1) to immediately implement the required action in reaction to the sensed position. The sensing operation may be continuous, so that the signal to increase or decrease ribbon speed can be monitored with greater precision.

During normal operation of the ribbon tensioning mechanism 10, drum 40 is always rotating in the rotational directions as it is driven by the advance of the ribbon 15 along its path from the feed spool 20 toward take-up spool 22. However, depending on the relative rotational speeds of the feed spool 20 and take-up spool 22, the planetary lever arm 30 and other forces, for example frictional forces from the printer head, causes the loop 17 to be formed in a variable sized semicircle around drum 40. When a signal reaches the controller that there is too large of a ribbon loop 17, the loop must be reduced in size, and that is done by the take-up spool 22 being signalled to increase the speed of rotation so that it takes up more of the ribbon 15 than is being supplied by the feed spool 20. Simultaneously, the feed spool may be signalled to slow down to supply ribbon at a slower rate and thus pulling back on the loop 17 and thereby reducing its length. Conversely, when the controller 300 recognizes that the ribbon 15 is under tension so that the loop 17 is too small, it signals the feed spool 20 to speed up and the take-up spool 22 to slow down so as to accommodate the condition of the loop 17 and return it to an equilibrium position.

One method to achieve this close monitoring and control is by utilizing a sensor that utilizes a predictive controller as a sensing mechanism 60 (FIGS. 7, 8). Such controllers are commercially available under the brand name Gear Motors from Brain Wave, located in Milan, Italy. The preferred sensor mechanism will now be described with reference to as shown in FIGS. 5-8 of the drawings. The mechanism comprises a predictive controller mechanism 60 that is configured to sense the exact position of the lever arm 30, and thus the tape loop 17, at all times.

In a preferred embodiment, the motor 48 works in conjunction with the sensing mechanism 60 to provide adequate, and essentially real time, control over the operation of arm 30 so as to provide a minimum reaction time of the arm 30 to sensed conditions. As shown in FIG. 7, the arm 30 pivots or rotates about a bushing ring 62 which rotates with the arm around the central axis CL.

Referring now mostly to FIGS. 6 and 7, the sensing mechanism 60 may comprise a second, concentric ring bushing 62 that is disposed around the drum shaft 42 and which extends into the housing of the motor 48. A portion of the planetary lever arm 30, distal to the tape 15 (FIGS. 1-4), is connected to the ring bushing 62 by an appropriate means, such as a bolt assembly 64, so as to provide a unitary structure. Alternatively, the ring bushing 62 and arm 30 may be an integral component (not shown). The concentric ring bushing 62 may be mounted on a journalled bearing contained within the motor housing (not shown) so that the arm 30, which rotates with the ring 62 can rotate within the arc defined by the aperture 44.

The concentric ring bushing 62 is manipulated by motion of the lever arm 30 to rotate about the axis CL, and the journal mount of the concentric ring bushing 62 constrains the motion of the lever arm 30 to the path described by the planetary half crescent aperture 44 shown in FIG. 4. That is, the rotation of the concentric ring bushing 62 permits the arm 30, and the roller guide 32, to travel only in approximately a half orbit around the cylindrically shaped drum 40 as shown by arrows CW and CCW in FIG. 7. The predictive controller mechanism 60 may include preferably electronic sensing components that are available in commercially available devices. Conversely, the sensors may be LED or other sensing devices, for example, motion or proximity detectors, etc., that are disposed at appropriate positions along the arc defined by the crescent aperture 44, (See A, B in FIG. 1). The significant feature of this invention however lies partly in the ability of the device to sense the tension in the tape or ribbon directly, as a result of the change in equilibrium position of the lever arm, and to send a signal to correct any over or under balance as soon as the movement from the equilibrium position is sensed. It is also important to note that no calculations of any parameter of the system are necessary, in that only the direct sensed signal is the triggering mechanism to activate the control to the spool motors.

An equilibrium condition of the planetary support lever arm 30 is reached by a balanced opposition of forces arising from the tension of the ribbon 15 and the countervailing bias of the biasing force generated by a biasing means, such as spring 210 (FIG. 7). The spring 210 ideally has a smooth or linear opposing force, irrespective of the amount of stretch that is in the spring at any particular position. The force provided by the biasing means is thus able to provide a constant bias of essentially equal magnitude throughout the rotation of the planetary support arm 30, and this constant biasing force may be assisted by a cam or gear 46 that is attached to the lever arm 30. Utilizing such a cam or grooved gear 46 is preferable because it can help provide some flexibility in the system and thereby avoid any sudden changes to the angular momentum of the arm 30 that may cause the loop 17 or ribbon 15 to either tangle or to break in the event that the printer head 12 generates too much frictional force to the tape or ribbon in the printing process.

With this configuration, the heat transfer printing device is characterized in that it incorporates a cylindrical loading drum 40 disposed after the thermal print head 12 in relationship to the normal direction of travel of the printing ribbon 15, onto which the printing ribbon 15 is directed and retained in conjunction with the roller guide 32 on the planetary lever support arm 30. Thus, the constant bias on the planetary support arm 30 exerting a biasing force, maintains constant tension on the ribbon 15 during the printing process.

Optionally, the heat transfer printing device 10 is provided with a rotation sensor 19 associated with one or more of the guide rollers 14 that indicates the amount of printing ribbon 15 that has already been transferred in order to control the actuation of the motors associated to the feed spool 20 and the take-up spool 22. This also may provide an indication of the need to change the printing ribbon feed spool 20 as it nears depletion from continual use in the printing process.

Referring now to FIG. 8, a perspective view of the preferred embodiment of the angular position indicator, monitoring and control mechanism 60 for the thermal printing device is shown. Since the connection and configuration of the support lever arm 30 and motor 48, including the mounting mechanism are essentially the same as that shown in FIGS. 6-7, these will not be described in detail herein. The structure provides for an angular position indicator 262, which is not incorporated into the motor housing 48, but is located externally adjacent to the wall 50. A plate, shown as disc 262 in FIG. 8, includes a plurality of substantially evenly spaced LED or other photosensors 264 that are disposed in a circumferential pattern adjacent the circumferential or semicircular edge of disc 262. Photosensors 264 are capable of determining the position of the support lever arm 30 as it is rotated through the angular path defined by the aperture 44 (FIG. 5). As the arm 30 is sensed by any one individual sensor 264, the position of the arm 30, and this of the roller guide 32, is thereby recognized, and a corresponding reaction of the electronic controller, shown in FIG. 8 as a Printed Circuit Board (PCB) 250, and corresponding printed circuits 253 and associated leads 65. The leads or other signal carriers 65 extending from the predictive controller mechanism 60 send the signal either to a CPU 300 (FIG. 9) for processing or directly or indirectly connected to the feed and take-up drive stepper motors (not shown) which drive the take-up and feed spools 20, 22, respectively (FIG. 1), so as to adjust the motor speeds to accommodate the newly sensed conditions.

Another feature related to the sensor 19 provides operational indicators of the status of the device 10 and the printing process as it proceeds. Referring now to FIG. 9, a central processing unit controller 300 is shown in schematic, which includes a number of connection points 302, 304 to provide electrical communication to the various elements of the printing device 10, for example, to receive the lead wires 67 from the sensor 48 (FIG. 7) or from optional sensor 19 (FIG. 1). The signals received from these and other sensors may be utilized to monitor and indicate the status of the device 310 by any of a number visual or auditory or other indications to the operator that the device requires attention, or gives a warning signal that it may require attention in the near future. A recording device, such as a digital cassette tape recorder 306, may keep a record of the signals received and any output signals that may be generated by the CPU controller 300, whether automatically or by operation of the user.

One port 304 of the CPU controller 300 is an output port to which lead wires 308 may be attached, and which at the other end of the lead wires 308 is attached a visual or light indicator 310. The light indicator may be configured to show one of three system conditions, by flashing or otherwise indicating an indicator color at one of three lights, which are colored red light 312, yellow light 314, and green light 316. The indicator for the green light 316 may signify that the system is in normal operation, for the red light that there is a system malfunction, for example, that the printer ribbon 15 is not traversing through the printer device 10, or a yellow light 312 which may indicate that the condition is still operational but that attention will soon be required, for example to indicate that spools 20 and 22 will have to be replaced because they have been used up in the printing operation. Other condition indicators may be programmed into the CPU controller 300, which will ultimately be determined by the requirement of the specific printer device 10.

The printing method used to keep constant the ribbon tension during the printing mainly consists of the following stages:

Transferring the printing ribbon 15 supplied from the feed spool 20;

Displacing the thermal print head 12 in a direction toward the printing ribbon 15;

Holding the printing ribbon 15 against the outer surface 42 of the loading drum 40, which revolves, and in conjunction with the planetary guide roller 32, creating a ribbon loop that will determine an essentially constant tension in the printing ribbon 15 during the printing stage; and

Collecting the loop formed on the loading drum 40 in the take-up spool 22.

In the preferred embodiment, the printing ribbon 15 is held against the loading drum 40 by the tension produced by the angular displacement of the planetary guide roller 32 and by the biasing force created by the biasing means 210.

The operation of the printing device can be summarized by the following operations:

a) Detection of the instantaneous speed of the material to be printed by an external speed sensor in contact therewith;

b) Delivery of a printing activation signal by an external signal (sensors or other devices) for the start of the printing operation;

c) Activation of the thermal print head and engagement of the print head and the thermal printing ribbon with the material to be printed;

d) Activation of the printing ribbon feed spool motor;

e) Activation of a suitable mechanism, including the support lever arm 30, by the controller 48 in order to load and attract the heat transfer ribbon on the loading drum to form the loop;

f) Placing the thermal print head near the transfer ribbon and printing on the material to be printed;

g) Activation of the printed transfer ribbon take-up spool to unload the loop formed on the loading drum, according to a sequence determined by the controller as it processes the signals received from a plurality of sensors;

h) Rotation of the feed spool motor in the opposite sense to recover the transfer ribbon lost during the acceleration of the feed spool and approaching of the thermal print head motor to the material to be printed.

An optional step of deactivation of the transfer ribbon take-up spool motor by the required amount according to the printing size is also considered.

The invention can be used in both continuous mode and for intermittent mode printers, with appropriate parameters being set for either.

The invention herein has been described and illustrated with reference to the embodiments of FIGS. 1-9, but it should be understood that the features and operation of the invention as described is susceptible to modification or alteration without departing significantly from the spirit of the invention. For example, the dimensions, size and shape of the various elements may be altered to fit specific applications. Other means of sensing may become available in the future that do not rely on the presently described mechanisms, but which would not be presently apparent to a person of ordinary skill. Accordingly, the specific embodiments illustrated and described herein are for illustrative purposes only and the invention is not limited except by the following claims.

1. Heat-transfer printing device provided with at least one input guide roller that guides a printing ribbon towards a drum placed after a thermal printing head and before output guide rollers, characterised in that it comprises a swivelling roller that turns about the drum with the printing ribbon located between them, forming a loop of printing ribbon on the drum that establishes a tension in the ribbon during printing.

2. Heat-transfer printing device according to claim 1, characterised in that it incorporates a spring associated to the swivelling roller that maintains the printing ribbon under tension.

3. Heat-transfer printing device according to previous claim 1, characterised in that the swivelling roller has a curved trajectory with its centre of curvature coinciding with the axis or rotation of the drum.

4. Heat-transfer printing device according to claim 1, characterised in that it incorporates a motor that provides a rotating motion to the swivelling roller to facilitate the initial assembly of the printing ribbon, being afterwards disconnected.

5. Heat-transfer printing device according to claim 2, characterised in that the spring consists of a torsion spring wound about the drum and connected on one end to the swivelling roller.

6. Heat-transfer printing device according to claim 1, characterised in that it is provided with sensors placed in correspondence with the ends of the trajectory of the swivelling roller.

7. Heat-transfer printing device according to claim 1, characterised in that the output shaft of the motor is placed in line with the axis of the drum, and connected to one end of a connecting rod attached on its other end to the swivelling roller, to which carries along with a rotation motion resulting from the rotation of the motor, the motor being afterwards disconnected.

8. A heat transfer printing device comprising:
a thermal print head,
a feed spool for printing ribbon driven by a motor,
entry guide rollers that direct the printing ribbon arriving from the feed spool toward the printing area, the printing area having a printing roller for supporting the material to be printed,
a take-up spool driven by a motor to which the printing ribbon is directed with the aid of guide rollers, and
a tape tension mechanism for monitoring and actuating a tensioner to maintain the tension of the printing ribbon between the feed spool and the take-up spool, the tension mechanism including a cylindrical loading drum having a surface and configured to provide a motive tensioning force to the printing ribbon when the drum is rotating, the drum being disposed after the thermal print head to which the printing ribbon is attached, the drum being biased by a biasing force in an angular direction sufficient to generate a motive force to the drum rotating the tape to form a tape loop created by the tensioner so as to maintain the tension of the ribbon during printing.

9. The heat transfer printing device according to claim 8 wherein the tape tension mechanism further comprises:
a pivotable lever support arm disposed adjacent the cylindrical loading drum and having a longitudinal axis extending in a direction essentially parallel to the axis of rotation of the cylindrical loading drum, the printing ribbon being threaded between the pivotable lever support arm and the cylindrical loading drum, whereby pivoting of the lever in one rotational direction increases a circumferential length of the printing ribbon loop which is generated around the cylindrical loading drum to provide the loop, and pivoting in the other rotational direction decreases the circumferential length of the printing ribbon loop.

10. The heat transfer printing device according to claim 8,
wherein the tape tension mechanism further comprises
a monitoring indicator associated with the pivotable lever support arm, the monitoring indicator providing a signal to a ribbon speed regulator and sending a signal command to increase or decrease the rotational speed of the take-up and the feed spools, thereby increasing or decreasing the tape speed at the cylindrical loading drum as needed for the printing operation on the printing ribbon and adjusting the circumferential length of the loop formed around the cylindrical drum.

11. The heat transfer printing device according to claim 10, wherein the tape tension mechanism monitoring indicator associated with the pivotable lever support arm is disposed on an opposed side of a mounting wall from the side on which printer ribbon and spools are mounted, the monitoring indicator being capable of sending a signal command to increase or decrease the rotational speed of the take-up and the feed spools, thereby adjusting the circumferential length of the loop formed around the cylindrical drum disposed on the opposite side of the wall form the monitoring indicator.

12. A method of heat transfer printing by maintaining tension on the printing ribbons comprising:
a) providing a printing device including a ribbon feed spool, a ribbon take up spool, a print head at a printing station and a means of delivering material to be printed to the printing station,
b) detecting the instantaneous speed of the material to be printed by an external speed sensor in closed proximity therewith;
c) delivering a printing activation signal by an external signal to commence the printing operation of a print head;
d) activating the thermal print head and engaging the thermal print head and the thermal printing ribbon with the material to be printed;
e) activating the printing ribbon feed spool motor to guide printing ribbon to a printing station and directing the printing ribbon to a cylindrical loading drum;
f) activating a suitable mechanism, including a support lever arm, in order to load and attract the heat transfer ribbon on the loading drum to form a ribbon loop;
g) placing the thermal print head near the transfer ribbon and printing on the material to be printed; and
h) activating the printed transfer ribbon take-up spool to unload the loop formed on the loading drum.

13. The method of heat transfer printing according to claim 12 wherein the activation step h) is performed according to a sequence determined by the controller as it processes the signals received from a plurality of sensors.

14. The method of heat transfer printing according to claim 12 wherein the method further comprises deactivation of the transfer ribbon take-up spool motor by the required amount according to the printing size.

15. The method of heat transfer printing according to claim 12 wherein the method is for a device that provides continuous mode of printing.

16. The method of heat transfer printing according to claim 12 wherein the method is for a device that provides an intermittent mode of printing.

17. A heat transfer printing device comprising:
a thermal print head;
a feed spool for printing ribbon driven by a motor, entry guide rollers that direct the printing ribbon arriving from the feed spool toward the printing area where there is a printing roller on which slides the material to be printed;
a take-up spool driven by a motor to which the printing ribbon is directed with the aid of guide rollers;
a cylindrical loading drum placed after the thermal print head, the loading drum having a surface and configured to have the printing ribbon adhere thereto, the printing ribbon forming a loop by the rotation of the loading drum in order to maintain tension on the ribbon during printing and maintaining the loop continuously under tension during operation of the heat transfer printing device; and
at least one rotation sensor associated with the guide roller that indicates the amount of ribbon transferred in order to control the actuation of the motors associated with the feed spool and take-up spool so as to take up the ribbon or provide additional slack in the ribbon and thereby to maintain constant tension of the ribbon at the thermal print head.

18. A heat transfer printing device comprising:
a thermal print head;
a feed spool for printing ribbon driven by a motor, entry guide rollers that direct the printing ribbon arriving from the feed spool toward the printing area where there is a printing roller on which slides the material to be printed;
a take-up spool driven by a motor to which the printing ribbon is directed with the aid of guide rollers; and
a cylindrical loading drum placed after the thermal print head, the loading drum having a surface and configured to have the printing ribbon adhere thereto, the printing ribbon forming a loop by the rotation of the loading drum in order to maintain tension on the ribbon during printing, wherein at least one portion of the loop is out of contact with the surface of the drum thereby to provide a reservoir in the tape to accommodate sudden changes in the tension of the tape.
